(19) United States
(12) Patent Application Publication
(10) Pub. No.: US 2025/0323994 A1
(43) Pub. Date: Oct. 16, 2025

(54) ELECTRONIC APPARATUS AND DYNAMIC WALLPAPER DISPLAY METHOD

(71) Applicant: ASUSTeK COMPUTER INC., Taipei City (TW)

(72) Inventors: Ya-Wen Mei, Taipei City (TW); Chih-Hsien Yang, Taipei City (TW)

(73) Assignee: ASUSTeK COMPUTER INC., Taipei City (TW)

(21) Appl. No.: 19/096,752

(22) Filed: Apr. 1, 2025

(30) Foreign Application Priority Data
Apr. 16, 2024 (TW) 113114126

(51) Int. Cl. H04M 1/72427

(52) U.S. Cl. CPC H04M 1/72427

(57) ABSTRACT

An electronic apparatus and a dynamic wallpaper display method thereof are provided. The dynamic wallpaper display method is adapted to an electronic apparatus including a display, and the method includes the following steps. Apparatus status information of the electronic apparatus is detected. An object visual feature of a dynamic object in a dynamic wallpaper is determined according to the apparatus status information. The dynamic object is rendered according to the object visual feature, the dynamic wallpaper including the dynamic object is displayed through the display.

### CROSS-REFERENCE TO RELATED APPLICATION

This application claims the priority benefit of Taiwan application serial no. 113114126, filed on Apr. 16, 2024. The entirety of the above-mentioned patent application is hereby incorporated by reference herein and made a part of specification.

### BACKGROUND

### Technical Field

The disclosure relates to an electronic apparatus and a dynamic wallpaper display method.

### Description of Related Art

With the advancement of technology, electronic apparatuses have become indispensable objects due to their powerful performance and rich applications in the daily lives of modern people. Generally, an electronic apparatus can display the user's favorite wallpaper through the display, so that the aesthetics of the electronic apparatus is improved and apparatus personalization is achieved. Static wallpapers can be photos or pictures that the user likes, while dynamic wallpapers can be short films or animations, etc. But whether it is a dynamic wallpaper or a static wallpaper, the electronic apparatus uses pre-stored files for presentation. However, when the wallpaper is displayed, the user needs to get close to the electronic apparatus most of the time to view small-sized text or icons, so as to learn the current apparatus status of the electronic apparatus.

### SUMMARY

The disclosure provides a dynamic wallpaper display method adapted to an electronic apparatus including a display, and the method includes the following steps. Apparatus status information of the electronic apparatus is detected. An object visual feature of a dynamic object in a dynamic wallpaper is determined according to the apparatus status information. The dynamic object is rendered according to the object visual feature, the dynamic wallpaper including the dynamic object is displayed through the display.

The disclosure further provides an electronic apparatus including a display, a storage device, and a processor. The storage device records a plurality of modules. The processor is coupled to the display and the storage device and executes the modules to execute the following operations. Apparatus status information of the electronic apparatus is detected. An object visual feature of a dynamic object in a dynamic wallpaper is determined according to the apparatus status information. The dynamic object is rendered according to the object visual feature, the dynamic wallpaper including the dynamic object is displayed through the display.

To sum up, in the embodiments of the disclosure, the object visual feature of the dynamic object in the dynamic wallpaper is determined according to the apparatus status information of the electronic apparatus. The object visual feature of the dynamic object in the dynamic wallpaper dynamically changes in response to a change in the apparatus status information.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of an electronic apparatus according to an embodiment of the disclosure.

FIG. 2 is a flow chart of a dynamic wallpaper display method according to an embodiment of the disclosure.

FIG. 3 is a schematic view of an example of a dynamic wallpaper and a dynamic object according to an embodiment of the disclosure.

FIG. 4 is a flow chart of the dynamic wallpaper display method according to an embodiment of the disclosure.

FIG. 5A to FIG. 5D are schematic views of examples of dynamic wallpapers according to an embodiment of the disclosure.

FIG. 6 is a flow chart of the dynamic wallpaper display method according to an embodiment of the disclosure.

FIG. 7A to FIG. 7B are schematic views of examples of dynamic wallpapers according to an embodiment of the disclosure.

FIG. 8A to FIG. 8B are schematic views of examples of dynamic wallpapers according to an embodiment of the disclosure.

FIG. 9A to FIG. 9D are schematic views of examples of dynamic wallpapers according to an embodiment of the disclosure.

FIG. 10A to FIG. 10B are schematic views of examples of dynamic wallpapers according to an embodiment of the disclosure.

FIG. 11A to FIG. 11B are schematic views of examples of dynamic wallpapers according to an embodiment of the disclosure.

FIG. 12 is a flow chart of the dynamic wallpaper display method according to an embodiment of the disclosure.

FIG. 13 is a schematic view of an example of adjustment of a position of the dynamic object according to an embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts. These embodiments are only part of the disclosure and do not present all implementation of the disclosure. More specifically, these embodiments serve as examples of the apparatus and method fall within the scope of the claims of the disclosure.

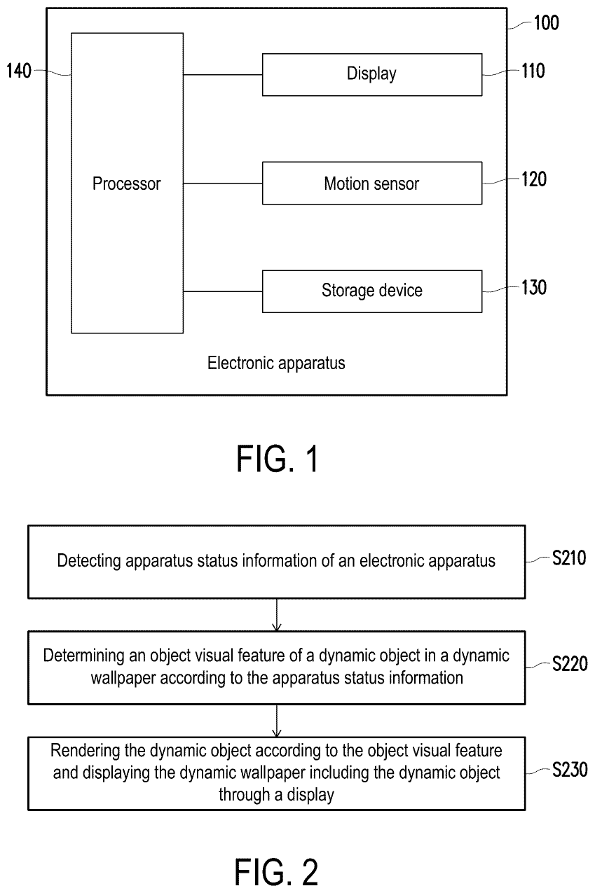

With reference to FIG. 1, a display apparatus 100 of this embodiment is, for example, a smart phone, a tablet computer, or a notebook computer with a wallpaper display function, but the disclosure is not limited thereto. The electronic apparatus 100 includes a display 110, a motion sensor 120, a storage device 130, and a processor 140, and functions of these devices are described in the following paragraphs.

The display 110 is, for example, a liquid crystal display (LCD), a light-emitting diode (LED) display, a field emission display (FED), an organic light-emitting diode (OLED) display, or other types of displays, but the disclosure is not limited thereto.

The motion sensor 120 is used to sense a motion status of the electronic apparatus 100. The motion sensor 120 is, for example, a gravity sensor, a gyroscope, an acceleration sensor, or a magnetometer and the like, which is not limited in disclosure.

The storage device 130 is used to store data such as a file, an image, a command, a program code, a software module, etc., and may be, for example, a fixed or movable random access memory (RAM) in any form, a read-only memory (ROM), a flash memory, a hard disc or other similar devices, an integrated circuit, and a combination thereof.

The processor 140 is, for example, a central processing unit (CPU), an application processor (AP), a programmable microprocessor for general or special use, a digital signal processor (DSP), a programmable controller, an application specific integrated circuit (ASIC), a programmable logic device (PLD), a graphics processing unit (GPU) or other similar devices, or a combination of the foregoing devices. The processor 140 may execute a program code, a software module, a command, etc. recorded in the storage device 130 to implement a dynamic wallpaper display method provided by the embodiments of the disclosure.

With reference to FIG. 1 and FIG. 2, the method provided by this embodiment is applicable to the electronic apparatus 100 provided by the foregoing embodiments, and steps of the dynamic wallpaper display method provided by this embodiment are described in detail as follows together with the various devices in the electronic apparatus 100.

In step S210, the processor 140 detects apparatus status information of the electronic apparatus 100. In some embodiments, the processor 140 may detect the apparatus status information periodically or conditionally. For instance, the processor 140 may detect the apparatus status information every second.

In some embodiments, the apparatus status information includes a performance mode of the electronic apparatus 100 or a hardware specification of a charging stand connected to the electronic apparatus 100. Further, the user can set the performance mode of the electronic apparatus 100 according to needs, which may be, for example, a high performance mode or a general performance mode. The hardware specification of the charging stand connected to the electronic apparatus 100 may be, for example, different charging wattages or different charging specifications.

In some embodiments, the apparatus status information includes a current status variable. The current status variable includes charging performance, load performance of the processor of the electronic apparatus 100, a network transmission rate of the electronic apparatus 100, a memory usage rate of the electronic apparatus 100, a power consumption rate of the electronic apparatus 100, or a processor usage rate of the electronic apparatus 100. Any status variable that can represent the apparatus status of the electronic apparatus 100 may fall within the scope of the disclosure. Further, the charging performance may be calculated based on a real-time charging current detected by a charging circuit of the electronic apparatus 100. The load performance of the processor of the electronic apparatus 100 is, for example, the load performance of the central processing unit, the application processor, or the graphics processing unit. The network transmission rate of the electronic apparatus 100 includes a data download rate or a data upload rate.

In step S220, the processor 140 determines an object visual feature of a dynamic object in a dynamic wallpaper according to the apparatus status information. To be specific, the processor 140 may detect the apparatus status information in a regular and real-time manner, so the object visual feature of the dynamic object is also updated regularly or non-regularly accordingly. That is, the object visual feature of the dynamic object may change accordingly in response to a change in the apparatus status information.

In some embodiments, the object visual feature includes an object size, an object color, or a combination thereof. In some other embodiments, the object visual feature may further include a shape, transparency, or other object visual features.

In step S230, the processor 140 renders the dynamic object according to the object visual feature and displays the dynamic wallpaper including the dynamic object through the display 110. Further, the dynamic wallpaper is rendered in real time based on the apparatus status information of the electronic apparatus 100. Therefore, when a user sees the dynamic object in the dynamic wallpaper displayed on the display 110, the user can instantly learn the apparatus status information of the electronic apparatus 100 according to the object visual feature of the dynamic object.

In some embodiments, the processor 140 displays the dynamic wallpaper on a lock screen, a home screen, or a screensaver screen through the display 110. That is, when the electronic apparatus 100 is in a locked status, the lock screen displayed by the display 100 may include the dynamic wallpaper rendered according to the apparatus status information.

Alternatively, when the electronic apparatus 100 is in an unlocked status, the home screen displayed by the display 100 may include the dynamic wallpaper rendered according to the apparatus status information. In some embodiments, the home screen displayed by the display 100 may further include icons or windows of a plurality of application programs. Alternatively, when the electronic apparatus 100 is in an idle status, the screensaver screen displayed by the display 100 may include the dynamic wallpaper rendered according to the apparatus status information.

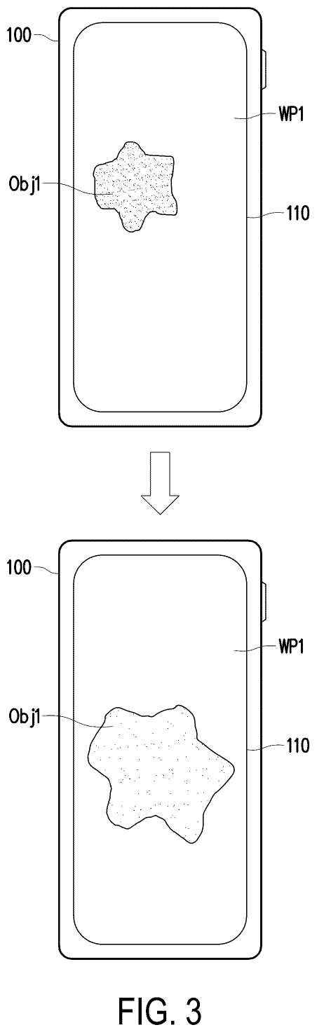

With reference to FIG. 3, the display 110 may display a dynamic wallpaper WP1, and the dynamic wall paper WP1 includes a dynamic object Obj1. The dynamic object Obj1 may be an irregular shape, a rectangle, a triangle, a circle, an ellipse, or other shapes, which is not limited by the disclosure. An object visual feature of the dynamic object Obj1 is determined according to the real-time apparatus status information of the electronic apparatus 100. Therefore, if the apparatus status information of the electronic apparatus 100 changes, an object size or an object color of the dynamic object Obj1 may dynamically change accordingly. In addition, under the condition that the object visual feature determined based on the apparatus status information is met, the dynamic object Obj1 may also dynamically move or dynamically deform based on a predetermined visual effect.

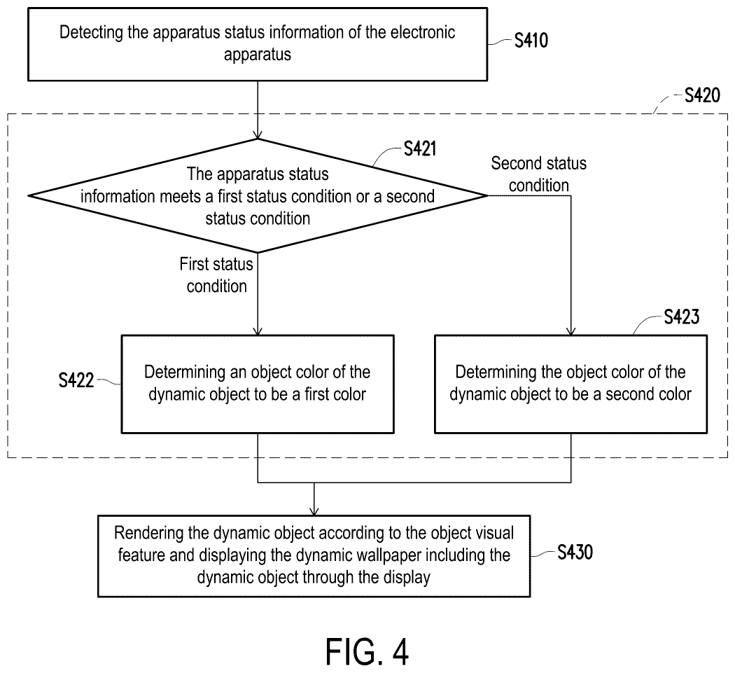

With reference to FIG. 1 and FIG. 4, the method provided by this embodiment is applicable to the electronic apparatus 100 provided by the foregoing embodiments, and the steps of the dynamic wallpaper display method provided by this embodiment are described in detail as follows together with the various devices in the electronic apparatus 100.

In step S410, the processor 140 detects the apparatus status information of the electronic apparatus 100. In step S420, the processor 140 determines the object visual feature of the dynamic object in the dynamic wallpaper according to the apparatus status information. In some embodiments, step S420 may be implemented as steps S421 to S423.

In step S421, the processor 140 determines that the apparatus status information meets a first status condition or a second status condition. In step S422, when the apparatus status information meets the first status condition, the processor 140 determines the object color of the dynamic object to be a first color. In step S423, when the apparatus status information meets the second status condition, the processor 140 determines the object color of the dynamic object to be a second color.

In some embodiments, the apparatus status information may be the performance mode of the electronic apparatus 100. When the performance mode of the electronic apparatus 100 is set to be the high performance mode, the processor 140 may determine that the apparatus status information meets the first status condition. When the performance mode of the electronic apparatus 100 is set to be the general performance mode, the processor 140 may determine that the apparatus status information meets the second status condition. That is, when the performance mode of the electronic apparatus 100 is set to be the high performance mode, the processor 140 determines that the object color of the dynamic object to be the first color. When the performance mode of the electronic apparatus 100 is set to be the general performance mode, the processor 140 determines that the object color of the dynamic object to be the second color.

It should be noted that the first color is different from the second color. In some embodiments, the first color is a warm color and the second color is a cool color.

Alternatively, in some embodiments, the apparatus status information may be the hardware specification of the charging stand connected to the electronic apparatus 100. When the hardware specification of the charging stand is to support a specific charging function, the processor 140 may determine that the apparatus status information meets the first status condition. When the hardware specification of the charging stand does not support a specific charging function, the processor 140 may determine that the apparatus status information meets the second status condition. That is, when the hardware specification of the charging stand supports a specific charging function, the processor 140 determines the object color of the dynamic object as the first color. When the hardware specification of the charging stand does not support a specific charging function, the processor 140 determines the object color of the dynamic object as the second color.

In step S430, the processor 140 renders the dynamic object according to the object visual feature and displays the dynamic wallpaper including the dynamic object through the display 110. In this embodiment, by viewing the object color of the dynamic object, the user can immediately know the performance mode of the electronic apparatus 100 or the hardware specification of the charging stand connected to the electronic apparatus 100.

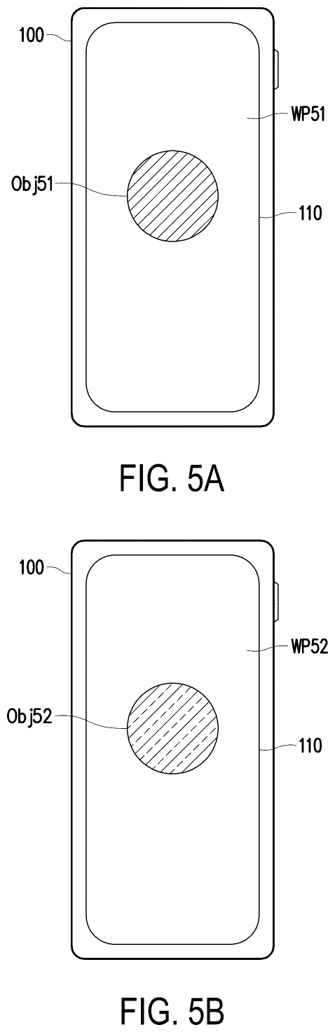

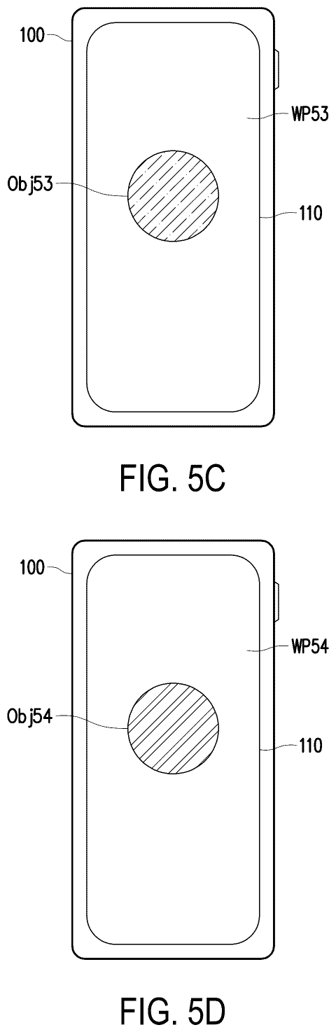

With reference to FIG. 5A to FIG. 5D, in this example, the processor 140 may also determine the object color, shape, area, and other visual features of the dynamic object based on the performance mode of the electronic apparatus 100 and the hardware specification of the charging stand (only color is used for explanation herein). It is assumed that the performance mode of the electronic apparatus 100 may be the high performance mode or the general performance mode, and the hardware specification of the charging stand may support a specific charging function or may not support a specific charging function. In this case, the processor 140 may determine the object color of the dynamic object according to the following Table 1, for example.

TABLE 1

| | High performance | General performance |
|---|---|---|
| | mode | mode |
| Supporting a specific | Color 1 | Color 2 |
| charging function | | |
| Not supporting a specific | Color 3 | Color 4 |
| charging function | | |

As shown in FIG. 5A, when the performance mode of the electronic apparatus 100 is the high performance mode and the hardware specification of the charging stand supports a specific charging function, an object color of a dynamic object Obj51 in a dynamic wallpaper WP51 is “color 1”. As shown in FIG. 5B, when the performance mode of the electronic apparatus 100 is the general performance mode and the hardware specification of the charging stand supports a specific charging function, an object color of a dynamic object Obj52 in a dynamic wallpaper WP52 is “color 2”. As shown in FIG. 5C, when the performance mode of the electronic apparatus 100 is the high performance mode and the hardware specification of the charging stand does not support a specific charging function, an object color of a dynamic object Obj53 in a dynamic wallpaper WP53 is “color 3”. As shown in FIG. 5D, when the performance mode of the electronic apparatus 100 is the general performance mode and the hardware specification of the charging stand does not support a specific charging function, an object color of a dynamic object Obj54 in a dynamic wallpaper WP54 is “color 4”.

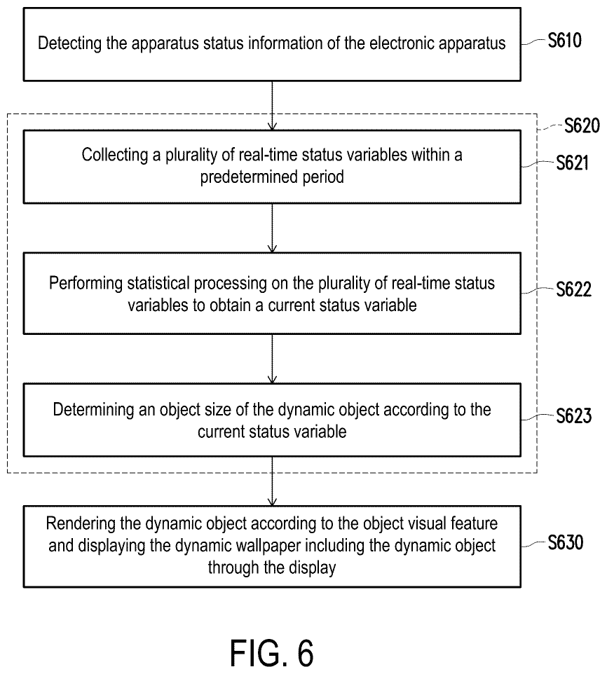

With reference to FIG. 1 and FIG. 6, the method provided by this embodiment is applicable to the electronic apparatus 100 provided by the foregoing embodiments, and the steps of the dynamic wallpaper display method provided by this embodiment are described in detail as follows together with the various devices in the electronic apparatus 100.

In step S610, the processor 140 detects the apparatus status information of the electronic apparatus 100. In step S620, the processor 140 determines the object visual feature of the dynamic object in the dynamic wallpaper according to the apparatus status information. In some embodiments, step S620 may be implemented as steps S621 to S623.

In this embodiment, the apparatus status information may be the current status variable, and the current status variable may be the charging performance, the load performance of the electronic apparatus 100, or the network transmission rate of the electronic apparatus 100. It should be noted that in this embodiment, the current status variable may be the statistical result of a plurality of real-time status variables.

In step S621, the processor 140 collects a plurality of real-time status variables within a predetermined period. To be specific, whenever the processor 140 obtains the real-time status variables periodically (e.g., every second), the processor 140 may record these real-time status variables. For instance, the processor 140 may collect a plurality of real-time status variables obtained in the past 10 seconds or 20 seconds. These real-time status variables also include the charging performance, the load performance of the electronic apparatus 100, or the network transmission rate of the electronic apparatus 100.

In step S622, the processor 140 performs statistical processing on the plurality of real-time status variables to obtain the current status variable. The statistical processing may include averaging operations, taking medians, or removing extreme values, etc. From another perspective, the processor 140 may perform statistical processing, such as moving average, on the plurality of real-time status variables, so that the object visual feature of the dynamic object may change smoothly.

In step S623, the processor 140 determines the object size or the object color of the dynamic object according to the current status variable. In some embodiments, the processor 140 may determine the object size or the object color of the dynamic object through a lookup table or a preset function.

In some embodiments, the current status variable is positively related to the object size. In other words, the greater the current status variable is, the larger the object size is. On the contrary, the smaller the current status variable is, the smaller the object size is. In some embodiments, the current status variable is positively related to saturation of the object color or a color component of a specific color channel (e.g., a red channel). In other words, the greater the current status variable is, the greater the color saturation is. On the contrary, the smaller the current status variable is, the smaller the color saturation is. Alternatively, the greater the current status variable is, the higher the color component of the red channel is. On the contrary, the smaller the current status variable is, the lower the color component of the red channel is.

In some embodiments, the object size may include the area of the object or a length of the dynamic object projected on a display edge. The abovementioned display edge may be a vertical display edge or a horizontal display edge. In other words, the object area of the dynamic object may change as the current status variable changes. Alternatively, the length of the dynamic object projected on the display edge may change as the current status variable changes. That is, the dynamic object may lengthen or shorten as the current status variable changes.

In step S630, the processor 140 renders the dynamic object according to the object visual feature and displays the dynamic wallpaper including the dynamic object through the display 110. In this embodiment, by viewing the object color of the dynamic object, the user can immediately know the charging performance of the electronic apparatus 100, the load performance of the processor, or the network transmission rate.

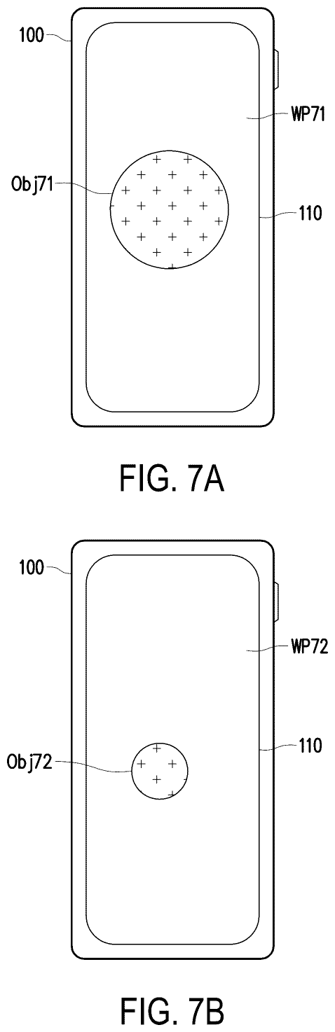

With reference to FIG. 7A to FIG. 5D, in this example, the processor 140 may determine the object area of the dynamic object according to the load performance of the processor 140 of the electronic apparatus 110. The object area of the dynamic object is positively related to the load performance of the processor 140 of the electronic apparatus 110. With reference to FIG. 7A and FIG. 7B, when the load performance of the processor 140 is high load (such as executing a large number of applications), an object area of a dynamic object Obj71 in a dynamic wallpaper WP71 is larger. When the load performance of the processor 140 is low load (for example, no application is executed), an object area of a dynamic object Obj72 in a dynamic wallpaper WP72 is smaller.

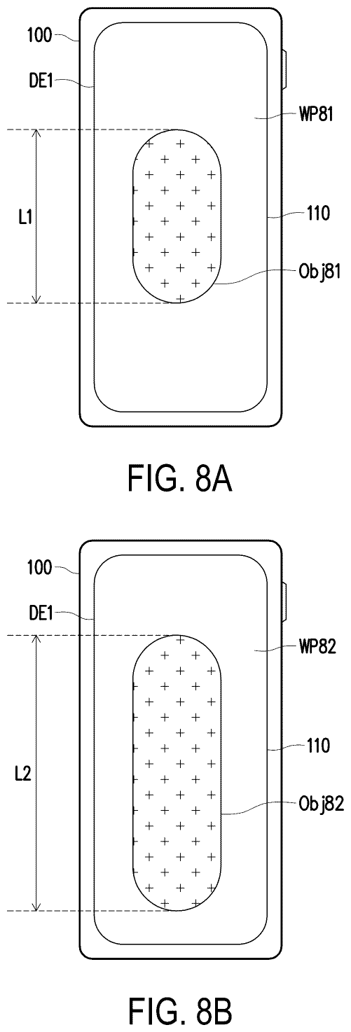

With reference to FIG. 8A to FIG. 5D, in this example, the processor 140 may determine the length of the dynamic object projected on the display edge according to the charging performance of the electronic apparatus 110. The length of the dynamic object projected on the display edge is positively related to the charging performance of the processor of the electronic apparatus 110. Comparing between FIG. 8A and FIG. 8B, when the charging performance of the processor is low-efficiency charging (such as low charging current), a length L1 of a dynamic object Obj81 in a dynamic wallpaper WP81 projected on a display edge DE1 is shorter. When the charging performance of the processor is high-efficiency charging (such as high charging current), a length L2 of a dynamic object Obj82 in a dynamic wallpaper WP82 projected on the display edge DE1 is longer.

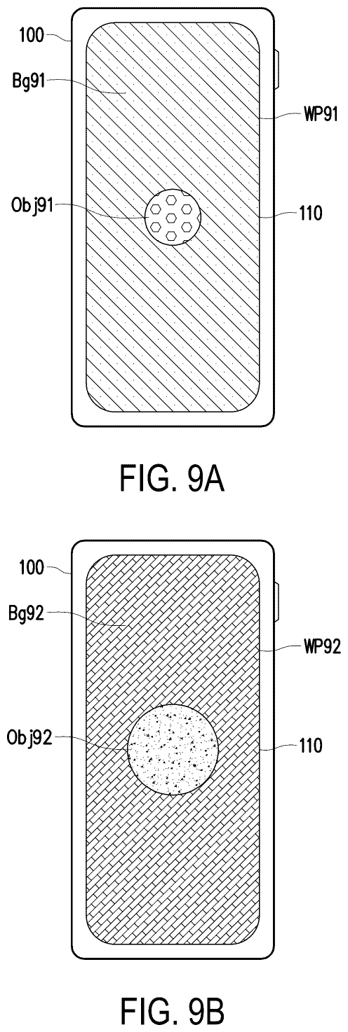

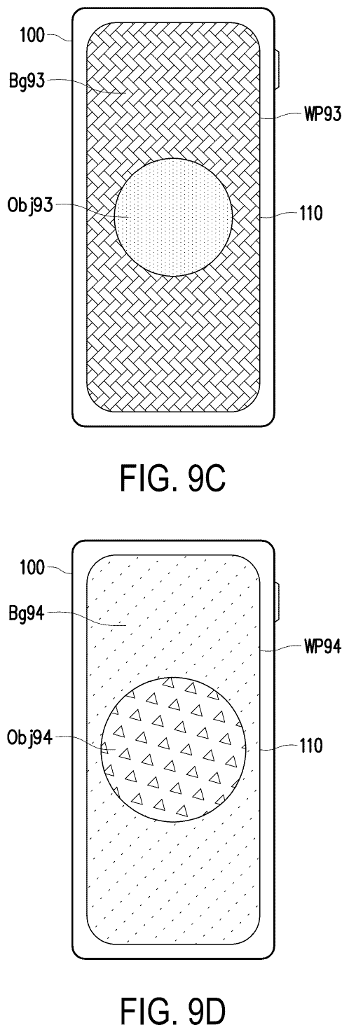

With reference to FIG. 9A to FIG. 9D, in this example, it is assumed that the electronic apparatus 100 is not plugged into the charging stand for charging. In this example, the processor 140 may determine the object color according to the performance mode of the electronic apparatus 100 and determine the object size and the object color together according to the load performance of the processor 140. It should be noted that in FIG. 9A to FIG. 9D, different mesh bases represent different colors. As shown in FIG. 9A, when the performance mode of the electronic apparatus 100 is the general performance mode and the load performance of the processor 140 is low load, a dynamic object Obj91 in a dynamic wallpaper WP91 may be a first color. In addition, a background color of a background region Bg91 of the dynamic wallpaper WP91 may also be determined according to the performance mode of the electronic apparatus 100 and the load performance of the processor 140, and may have a second color.

As shown in FIG. 9B, when the performance mode of the electronic apparatus 100 is the general performance mode and the load performance of the processor 140 is high load, a dynamic object Obj92 in a dynamic wallpaper WP92 may be a third color. In addition, a background color of a background region Bg92 of the dynamic wallpaper WP92 may also be determined according to the performance mode of the electronic apparatus 100 and the load performance of the processor 140, and may have a fourth color. In addition, comparing between FIG. 9A and FIG. 9B, an object area of the dynamic object Obj91 may be smaller in response to the low load of the processor 140, and an object area of the dynamic object Obj92 may be larger in response to the high load of the processor 140.

In addition, as shown in FIG. 9C, when the performance mode of the electronic apparatus 100 is the high performance mode and the load performance of the processor 140 is low load, a dynamic object Obj93 in a dynamic wallpaper WP93 may be a fifth color. In addition, a background color of a background region Bg93 of the dynamic wallpaper WP93 may also be determined according to the performance mode of the electronic apparatus 100 and the load performance of the processor 140, and may have a sixth color.

As shown in FIG. 9D, when the performance mode of the electronic apparatus 100 is the high performance mode and the load performance of the processor 140 is high load, a dynamic object Obj94 in a dynamic wallpaper WP94 may be a seventh color. In addition, a background color of a background region Bg94 of the dynamic wallpaper WP94 may also be determined according to the performance mode of the electronic apparatus 100 and the load performance of the processor 140, and may have an eighth color. In addition, comparing between FIG. 9C and FIG. 9D, an object area of the dynamic object Obj93 may be smaller in response to the low load of the processor 140, and an object area of the dynamic object Obj94 may be larger in response to the high load of the processor 140.

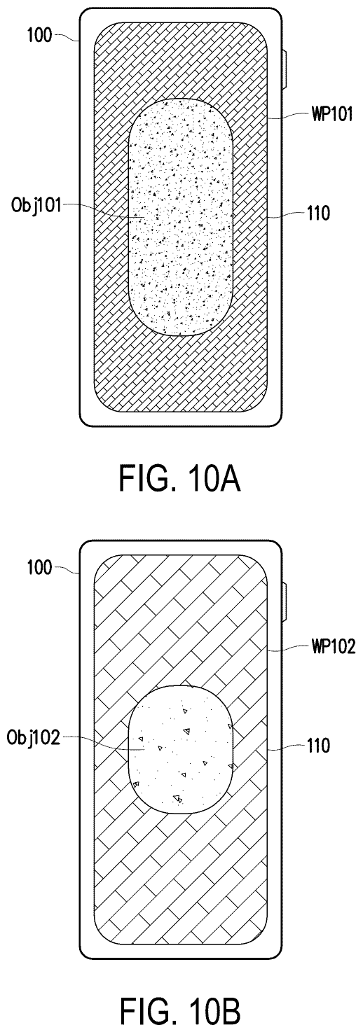

With reference to FIG. 10A to FIG. 10B, in this example, it is assumed that the electronic apparatus 100 is plugged into the charging stand for charging and the performance mode of the electronic apparatus 100 is the general performance mode. In this example, the processor 140 may determine the object color according to the performance mode of the electronic apparatus 100 and determine the object size and the object color together according to the charging performance. As shown in FIG. 10A, when the performance mode of the electronic apparatus 100 is the general performance mode and charging efficiency is high-rate charging, a dynamic object Obj101 in a dynamic wallpaper WP101 may be the first color. As shown in FIG. 10B, when the performance mode of the electronic apparatus 100 is the general performance mode and the charging efficiency is low-rate charging, a dynamic object Obj102 in a dynamic wallpaper WP102 may be the second color. In addition, comparing between FIG. 10A and FIG. 10B, a length of the dynamic object Obj101 projected on a vertical display edge may be extended in response to high-rate charging, and a length of the dynamic object Obj102 projected on the vertical display edge may be shortened in response to low-rate charging.

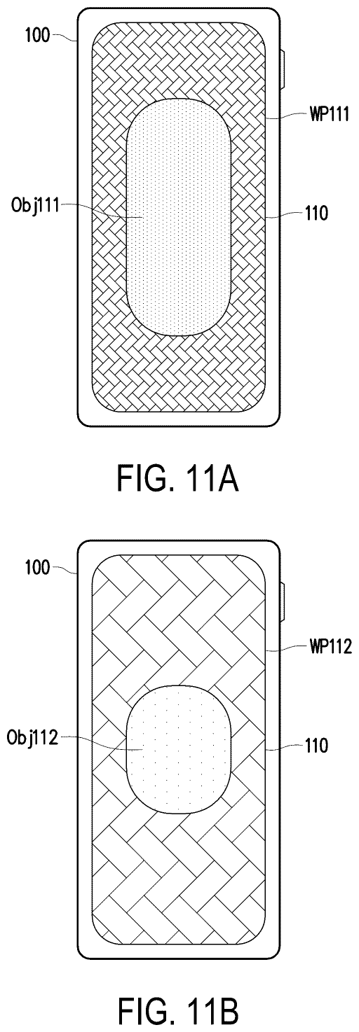

With reference to FIG. 11A to FIG. 11B, in this example, it is assumed that the electronic apparatus 100 is plugged into the charging stand for charging and the performance mode of the electronic apparatus 100 is a high-speed performance mode. In this example, the processor 140 may determine the object color according to the performance mode of the electronic apparatus 100 and determine the object size and the object color together according to the charging performance. As shown in FIG. 11A, when the performance mode of the electronic apparatus 100 is the high-speed performance mode and the charging efficiency is high-rate charging, a dynamic object Obj111 in a dynamic wallpaper WP111 may be the third color. As shown in FIG. 11B, when the performance mode of the electronic apparatus 100 is the high-speed performance mode and the charging efficiency is low-rate charging, a dynamic object Obj112 in a dynamic wallpaper WP112 may be the fourth color. In addition, comparing between FIG. 11A and FIG. 11B, a length of the dynamic object Obj111 projected on the vertical display edge may be extended in response to high-rate charging, and a length of the dynamic object Obj112 projected on the vertical display edge may be shortened in response to low-rate charging. It should be noted that in FIG. 10A, FIG. 10B, FIG. 11A, and FIG. 11B, different mesh bases represent different colors.

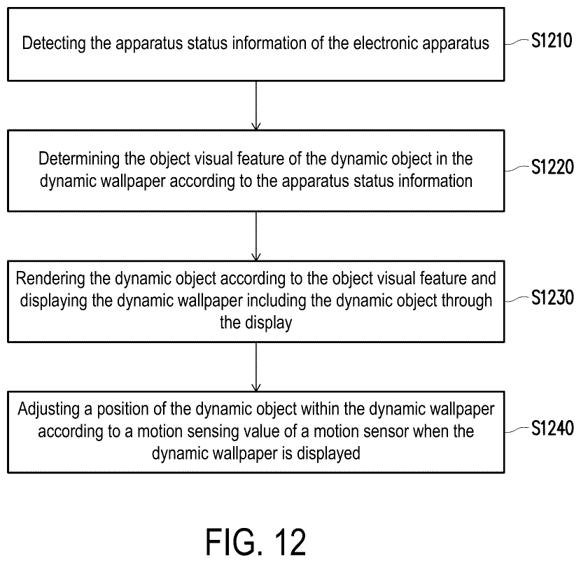

With reference to FIG. 1 and FIG. 12, the method provided by this embodiment is applicable to the electronic apparatus 100 provided by the foregoing embodiments, and the steps of the dynamic wallpaper display method provided by this embodiment are described in detail as follows together with the various devices in the electronic apparatus 100.

In step S1210, the processor 140 detects the apparatus status information of the electronic apparatus 100. In step S1220, the processor 140 determines the object visual feature of the dynamic object in the dynamic wallpaper according to the apparatus status information. In step S1230, the processor 140 renders the dynamic object according to the object visual feature and displays the dynamic wallpaper including the dynamic object through the display 110.

It should be noted that in step S1240, when the dynamic wallpaper is displayed, a position of the dynamic object within the dynamic wallpaper is adjusted according to a motion sensing value of the motion sensor 120. The motion sensing value of the motion sensor 120 may be used to determine a moving speed and a moving direction of the electronic apparatus 100. The processor 140 may determine a moving trajectory and a moving speed of the dynamic object according to the moving speed and the moving direction of the electronic apparatus 100. For instance, the moving direction of the electronic apparatus 100 may be the same as the moving direction of the dynamic object. The moving speed of the electronic apparatus 100 is positively related to the moving speed of the dynamic object. That is, when the user shakes the electronic apparatus 100, the dynamic object in the dynamic wallpaper also moves accordingly.

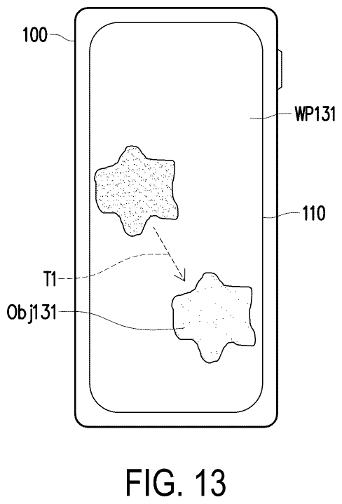

For instance, with reference to FIG. 13, which is a schematic view of an example of adjustment of the position of the dynamic object according to an embodiment of the disclosure. When the electronic apparatus 100 is shaken, the processor 140 may adjust a position of a dynamic object Obj131 within a dynamic wallpaper WP131, so that the dynamic object Obj131 moves along a moving trajectory T1. A direction of the moving trajectory Tl is determined according to the motion sensing value of the motion sensor 120. Therefore, the movement of dynamic object may bring more diverse visual changes and interest, and allow the user to experience the connection and interaction between the apparatus and the user.

In view of the foregoing, in the embodiments of the disclosure, the object visual feature of the dynamic object in the dynamic wallpaper may be determined according to the apparatus status information of the electronic apparatus. The object visual feature of the dynamic object in the dynamic wallpaper may dynamically change in response to a change in the apparatus status information. Based on the above, the user can immediately learn the status of the electronic apparatus by viewing the dynamic wallpaper, so that the convenience of using the electronic apparatus is improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A dynamic wallpaper display method adapted to an electronic apparatus comprising a display, the method comprising:
detecting apparatus status information of the electronic apparatus;
determining an object visual feature of a dynamic object in a dynamic wallpaper according to the apparatus status information; and
rendering the dynamic object according to the object visual feature and displaying the dynamic wallpaper comprising the dynamic object through the display.

2. The dynamic wallpaper display method according to claim 1, wherein the step of displaying the dynamic wallpaper comprising the dynamic object through the display comprises:
displaying the dynamic wallpaper on a lock screen, a home screen, or a screensaver screen through the display.

3. The dynamic wallpaper display method according to claim 1, wherein the object visual feature comprises an object size, an object color, an object shape, transparency, or a combination thereof.

4. The dynamic wallpaper display method according to claim 3, wherein the step of determining the object visual feature of the dynamic object in the dynamic wallpaper according to the apparatus status information comprises:
determining the object color of the dynamic object to be a first color when the apparatus status information meets a first status condition; and
determining the object color of the dynamic object to be a second color when the apparatus status information meets a second status condition.

5. The dynamic wallpaper display method according to claim 4, wherein the first color is a warm color and the second color is a cool color.

6. The dynamic wallpaper display method according to claim 4, wherein the apparatus status information comprises a performance mode of the electronic apparatus or a hardware specification of a charging stand connected to the electronic apparatus.

7. The dynamic wallpaper display method according to claim 3, wherein the apparatus status information comprises a current status variable, and the step of determining the object visual feature of the dynamic object in the dynamic wallpaper according to the apparatus status information comprises:
determining the object size or the object color of the dynamic object according to the current status variable, wherein the current status variable is positively related to the object size, and the object size comprises an object area or a length of the dynamic object projected on a display edge.

8. The dynamic wallpaper display method according to claim 7, wherein the step of determining the object visual feature of the dynamic object in the dynamic wallpaper according to the apparatus status information further comprises:
collecting a plurality of real-time status variables within a predetermined period; and
performing statistical processing on the plurality of real-time status variables to obtain the current status variable.

9. The dynamic wallpaper display method according to claim 7, wherein the current status variable comprises charging performance, load performance of a processor of the electronic apparatus, a network transmission rate of the electronic apparatus, a memory usage rate of the electronic apparatus, a power consumption rate of the electronic apparatus, or a processor usage rate of the electronic apparatus.

10. The dynamic wallpaper display method according to claim 1, further comprising:
adjusting a position of the dynamic object within the dynamic wallpaper according to a motion sensing value of a motion sensor when the dynamic wallpaper is displayed.

11. An electronic apparatus, comprising:
a display;
a storage device recording a plurality of modules; and
a processor coupled to the display and the storage device, executing the modules, and configured to:
detect apparatus status information of the electronic apparatus,
determine an object visual feature of a dynamic object in a dynamic wallpaper according to the apparatus status information, and
display the dynamic wallpaper comprising the dynamic object through the display.
